(19) United States
(12) Patent Application Publication
(10) Pub. No.: US 2026/0200789 A1
(43) Pub. Date: Jul. 16, 2026

(54) PROCESS FOR PRODUCING AN MAS GLASS WITH HIGH ETCH HOMOGENIEITY

(71) Applicant: QSIL GMBH QUARZSCHMELZE ILMENAU, Ilmenau (DE)

(72) Inventors: Heinz FABIAN, Großostheim (DE); Lars ORTMANN, Jena (DE); Robert HAHN, Ilmenau (DE); Frank-Peter LUDWIG, Erfurt (DE)

(21) Appl. No.: 19/136,050

(22) PCT Filed: Dec. 12, 2023
(86) PCT No.: PCT/EP2023/085295

§ 371 Date: Jun. 5, 2025

(30) Foreign Application Priority Data
Dec. 15, 2022 (DE) 10 2022 133 501.1

(51) Int. Cl. C03C 3/085; C03B 1/02; C03C 4/20; C03C 15/02

(52) U.S. Cl. CPC C03C 3/085; C03C 4/20; C03B 1/02; C03C 15/02

(57) ABSTRACT

A process for producing an MAS glass is described wherein 10 to 40 mol % of MgO, 5 to 30 mol % of Al₂O₃ and 40 to 70 mol % of SiO₂ or precursors of these raw materials are mixed, the mixture is melted, the melt is cooled and comminuted to afford particles of less than 10 mm, preferably less than mm and particularly preferably less than 2 mm in diameter. The particles are heated and melted and the melt is cooled, as well as an MAS glass obtainable by this process, and a component including the MAS glass and the use of such a component are also disclosed.

The present invention relates to a process for producing an MAS glass, to an MAS glass obtainable by this process, to a component comprising this MAS glass, and to the use of such a component.

Plasma-enhanced dry etching—also referred to for short as “plasma etching”—is a vital technology in the production of ultrafine structures for semiconductor components, for high-resolution displays, and in the manufacture of solar cells.

EP 3 708 547 A1 describes plasma etching in a vacuum reactor at a relatively high temperature in a highly corrosive atmosphere. The vacuum reactor here is flushed at low pressure with an etching gas. High-frequency discharge between electrodes, or electrode-less microwave discharge, generates a highly reactive, actively etching plasma.

U.S. Pat. No. 7,084,084 B2 discloses the use a of halogenated gas, such as a fluorine-containing or chlorine-containing gas, for plasma etching. The halogenated gas and its plasma have high reactivity and are therefore employed in different steps, for example as etching gas in an etching process or cleaning process in the semiconductor industry. The halogenated gases and plasmas used are, for example, fluorine-containing such as F₂, HF, CF₄, C₂F₆, C₃F₈, C₄F₈, CHF₃, SF₆ and NF₃, chlorine-containing such as Cl₂, HCl, BCl₃ and CCl₄, and bromine-containing such as Br₂ and HBr.

Elemental fluorine and ions and radicals of fluorine not only exhibit the desired etching effect but also react with the other components exposed to the plasma. The corrosive wear which this causes can lead to the generation of particles and to severe alteration of the components employed, which then have to be replaced.

Owing to its high chemical resistance to many substances used in the manufacturing operation and to its relatively high temperature resistance, quartz glass is commonly used for components that are particularly stressed. relates in This particular to the etching chamber. Under fluorine-containing etching gas, however, the SiO₂ in the quartz glass is subject to reaction with reactive fluorine to form SiF₄. The boiling point of SiF₄ is −86° C., and so this compound readily undergoes transition to the gas phase, a transition associated with severe corrosion at the surface of the quartz glass and with the formation of particles.

One known attempt at counteracting the corrosion of quartz due to fluoridation is doping. The aim in this case is for the element added to the quartz glass to form, with the halogenated gas used, a compound which has higher sublimation temperature or higher boiling point than the silicon halide formed in the quartz glass. The glass network formed as a result has a reduced etching rate.

Doping can be achieved by adding oxides of Sm, Eu, Yb, Pm, Nd, Ce, Tb, Gd, Ba, Mg, Y, Im, Dy, Ho, Er, Cd, Co, Cr, Cs and/or Zr, although these can lead to destruction of the quartz glass network.

Specifically, this causes breakup of the SiO₂ network of which the quartz glass is made, because of the incorporation of secondary elements, and there is frequently local formation of non-crosslinking oxygen with a weak binding force. This unwanted phenomenon is very deleterious, especially under etching conditions. Thus it is possible for the addition of secondary elements to tend to raise the local glass etching rate and to reduce durability.

In order to retain glass stability in spite of doping, a possibility is to admix Al, In, Cu, Fe, Bi, Ga and/or Ti as oxides, additionally.

One known, doped glass mixture consists to an extent of 20% by weight of MgO, 20% by weight of Al₂O₃ and 60% by weight of SiO₂ and is referred to as MAS glass. In etching operations with fluorine-containing etching gas, the glass mixture undergoes reaction with reactive fluorine to form MgF₂. The boiling point of MgF₂ is >2200° C., and so it undergoes virtually no transition to the gas phase, thereby entertaining reduced corrosion at the surface of the glass mixture and leading to a minimized etching rate. Further dopes as well, such as with MgF₂, to reduce the etching rate further are known from the prior art (WO2022075687A1).

A disadvantage affecting the production of known MAS glasses is that the melting of the magnesium, aluminum and silicon oxide components for producing the glass is oftentimes accompanied by inhomogeneities of materials. These inhomogeneities may come about because of inadequate mixing of the raw materials or else by separation or local crystallization during the production operation. These inhomogeneities of material also lead to locally different etching rates and hence to nonuniform etching ablation. They therefore present an increased risk of particle formation during the plasma etching operation. Obvious qualitative markers of inhomogeneities here are streaks or cloudy glass regions. A very good quantitative indicator of inhomogeneities of material with different etching rates is the measurement of the surface roughness of the glass after an etching operation. The surface topology reflects the spatial distribution of the inhomogeneities and the associated etching rate inhomogeneity with very great precision.

For plasma etching with fluorine-containing plasma, a material is needed which exhibits not only a low etching rate but also high etch homogeneity and hence low release of particles during the etching operation. Known from the prior art, indeed, are materials of the type XO—Al₂O₃—SiO₂ (X=alkaline earth metals, especially Mg, Ca and Ba) which have relatively low etching rates. However, these materials often have the disadvantage that they exhibit low etch homogeneity and so can lead to release of particles during the etching procedure.

It is therefore an object of the present invention to eliminate the disadvantages of the prior art. The intention in particular in a simple way is to provide an MAS glass which is homogeneous and for which the crystallization and the separation on curing are minimized. The MAS glass is additionally to exhibit a reduced etching rate and high etch homogeneity.

These objects have surprisingly been achieved by a process for producing an MAS glass in accordance with claim 1 and by an MAS glass in accordance with claim 10.

Advantageous developments are described in the dependent claims.

The MAS glasses produced with the process of the invention have the advantage that they are extremely homogeneous, so avoiding crystallization and separation. Moreover, the MAS glasses of the invention feature a reduced etching rate and a high etch homogeneity. These advantageous properties can also be reliably achieved for larger dimensions of the MAS glasses and/or components.

Below, numerous specific details are discussed for enabling comprehensive understanding of the present subject matter. For the skilled person, however, it is obvious that the subject matter can also be practiced and reworked without these specific details.

All features of one embodiment can be combined with features of another embodiment if the features of the different embodiments are reconcilable.

The terminology used in the description of the present disclosure serves only for describing defined embodiments and is not to be understood as a limitation on the subject matter. As used in the present description and the claims, the singular forms “a”, “an”, “one” and “the” are to be understood to also include the plural forms, unless the context unambiguously dictates something to the contrary. This is also true the other way round, i.e., the plural forms also include the singular forms. It is also self-evident that the term “and/or” as used herein refers to and includes all possible combinations of one or more of the associated elements listed. It is additionally self-evident that the terms “includes”, “inclusive”, “comprises” and/or “comprising” when used in the present description and the claims specify the presence of the stated features, steps, operations, elements and/or components, but do not rule out the presence or addition of one or more other features, steps, operations, elements, components and/or groups.

In the present description and the claims, the terms “includes”, “comprises” and/or “comprising” may also mean “consisting of”-that is, the presence or addition of one or more other features, steps, operations, elements, components and/or groups is ruled out.

The present invention relates to a process for producing an MAS glass, characterized in that
a) 10 to 40 mol % of MgO, 5 to 30% mol % of Al₂O₃ and 40 to 70 mol % of SiO₂ or precursors of these raw materials are mixed,
b) the mixture from step a) is melted,
c) the melt from step b) is cooled and comminuted to give particles having a diameter of less than 10 mm, preferably less than 5 mm and more preferably less than 2 mm,
d) the particles from step c) are heated and melted, and
e) the melt from step d) is cooled.

By precursors of these raw materials, preferably the corresponding hydroxides and/or carbonates of MgO and Al₂O₃ are meant.

In one preferred embodiment, the process of the invention is characterized in that steps c), d) and e) are carried out repeatedly, with the melt in step c) being in each case the melt produced before by step e). Repeatedly means 2, 3, 4, 5, etc. times. Repeatedly carrying out steps c), d) and e) allows the homogeneity to be further improved.

In one preferred embodiment, the process of the invention is characterized in that the mixture in steps b) and/or d) is heated to a temperature of 1200 to 2000° C., preferably to a temperature of 1500 to 1750° C. and more preferably 1550 to 1700° C.

In one preferred embodiment, the process of the invention is characterized in that the duration of step b) is 0.1 to 10 hours, preferably 0.1 to 7 hours.

In one preferred embodiment, the process of the invention is characterized in that the duration of step d) is 0.1 to 10 hours, preferably 0.1 to 7 hours.

In one preferred embodiment, the process of the invention is characterized in that the mixture from step d) is cooled in step e) to a temperature of below 25° C.

In one preferred embodiment, the process of the invention is characterized in that the mixture from step d) is cooled in step e) initially rapidly to a temperature of 600 to 900° C. and subsequently much more slowly to a temperature of below 25° C.

Rapidly means, for example, cooling of more than 75 K per minute, preferably of more than 90 K per minute and of less than 120 K per minute. Slowly means, for example, cooling of less than 5 K per minute, preferably of less than 2.5 K per minute and of greater than 0.5 K per minute.

Rapid cooling down into the temperature range from 600 to 900° C. has the advantage of minimizing the risk of crystallization, thereby further preventing the formation of inhomogeneities. The subsequent slow cooling to room temperature prevents the formation of stresses or cracks.

In one preferred embodiment, the process of the invention is characterized in that the mixture in steps b) and/or d) is heated in Pt and/or Pt/Rh crucibles.

In one preferred embodiment, the process of the invention is characterized in that the mixture is cooled in step e) in a steel mold coated with release agent, in a lehr.

In one preferred embodiment, the process of the invention is characterized in that less than 0.01 mol % of additions of materials comprising fluorine compounds and/or yttrium compounds is added during the production of the MAS glass.

The present invention further relates to an MAS glass obtainable by the process described above.

In this context, all definitions and preferred embodiments recited above for the process of the invention are valid analogously for the MAS glass obtainable by the process described above.

In one preferred embodiment, the MAS glass obtainable by the process of the invention described above is characterized in that the MAS glass comprises 10 to 40 mol % of MgO, 5 to 30% mol % of Al₂O₃ and 40 to 70 mol % of SiO₂, is X-ray-amorphous and in that the surface of the glass after the etching operation described below has a mean roughness (Rₐ) of less than 50 nm, preferably of less than 30 nm, more preferably of less than 10 nm and very preferably of less than 5 nm, the mean roughness (Rₐ) having been determined in accordance with ISO 4287-1:1984.

In one preferred embodiment, the MAS glass obtainable by the process of the invention described above is characterized in that the surface of the glass after the etching operation described below has an average roughness depth (R_{z}) of less than 100 nm, preferably of less than 70 nm, more preferably of less than 50 nm and very preferably of less than 35 nm, the average roughness depth (R_{z}) having been determined in accordance with ISO 4287-1:1984.

In the context of the present invention, etching homogeneity refers to the local variations in the etching characteristics. The smaller the local variations in the etching characteristics, the higher the etch homogeneity of the MAS glass. The etch homogeneity may be determined quantitatively on the basis of a standardized measurement of the surface roughness (Ra and Rz) of the MAS glass after a defined etching operation.

The etch homogeneity is described by the unevenness of the surface after the etching operation and may be represented quantitatively by variables such as the mean roughness (Rₐ) and the average roughness depth (R_{z}). A low figure for Rₐ and R_{z} is an expression of high etch homogeneity. Rₐ is defined by the mean distance of a measurement point on the surface to the center line. R_{z} is defined by the average of individual roughness depths of five successive individual measurement sections in the roughness profile. The roughness variables Rₐ and R_{z} are determined in accordance with ISO 4287-1:1984.

The etch homogeneity of the MAS glasses may be successfully determined by steps as follows (specific etching operation): 1. cleaning of the MAS glass, 2. masking of defined glass regions with Kapton tape, and 3. an etching operation.

The MAS glasses are cleaned by the following wet-chemical steps:
1. 100% ultrasound for 10 min with Tickopur R33 (at 5%),
2. solvent cleaning with acetone and isopropanol, and
3. rinsing with DI water and drying.

Tickopur R33 (at 5%) is a universal ultrasound cleaner which contains 5 to 15% anionic surfactants, 5 to 15% phosphate, less than 5% nonionic surfactants, less than 5% silicate and complexing agent.

The masking of defined glass regions with Kapton tape takes place by partial taping off of defined regions of the substrate with plasma-stable Kapton film.

The etching operation for smoothing the surface of the MAS glasses of the invention is carried out in the Sentech Si-500 apparatus. In this operation, the following parameters are set in the associated execution software as follows:
1. ICP 500 W,
2. HF bias 200 W,
3. flow control 100% (0.25 Pa),
4. CHF₃ 30 sccm,
5. etching time (cyclical, 2 min etching, 3 min cooling),
6. He backside cooling 1000 Pa,
7. heating power 0% and
8. Al sampling.

The surface roughnesses of the glasses were determined in accordance with ISO 4287-1:1984. The etching depths were determined by measuring the etch profile (that is, a section through the etching step) in an optical microscope. The etching rates were determined as a function of time relative to the etch profile.

In comparison to an undoped quartz glass, the MAS glass of the invention exhibits an about eight times lower etching rate (nm/min) with comparably good etch homogeneity (Ra and Rz). In comparison to known MAS glass, the MAS glass of the invention displays better etch homogeneity (Ra and Rz). These advantageous properties are obtained, surprisingly, because of the use of the process of the invention.

In one preferred embodiment, the MAS glass obtainable by the process of the invention described above is characterized in that it is X-ray-amorphous.

An X-ray-amorphous MAS glass is a glass without extended regions of long-range crystalline order, so that when analyzed accordingly it yields only very widespread X-ray reflections (referred to as the glass hill).

In the context of the present invention, X-ray-amorphous means that there are no crystalline regions larger than 10 nm in the MAS glass, something which may be determined using a diffractometer, for example.

In one preferred embodiment, the MAS glass of the invention obtainable by the process of the invention described above is characterized in that it comprises 20 to 40 mol % of MgO, 5 to 30 mol % of Al₂O₃ and 40 to 70 mol % of SiO₂, preferably 25 to 35 mol % of MgO, 10 to 25 mol % of Al₂O₃ and 50 to 65 mol % of SiO₂.

In one preferred embodiment, the MAS glass obtainable by the process of the invention described above is characterized in that the MAS glass contains less than 0.01 mol % of additions of materials comprising fluorine compounds and/or yttrium compounds. An advantage of this is that the risk of formation of local inhomogeneities during the operation of producing the material is further minimized.

The homogeneity of an optical substrate characterizes changes in the refractive index that lead to deformation of the transmitted wave front and polarizing transfer effects. A high degree of homogeneity or small change is important especially for applications with high-power lasers. Fluctuations in homogeneity come about as a result of the melting processes during production of materials. Inaccuracies in mixing and thermodynamic imbalances lead to density fluctuations. Furthermore, deformations may occur as a result of cooling and temperature conditioning processes. Inhomogeneities occur in the form of overall inhomogeneity (deviation in the refractive index in the glass piece as a whole) or in the form of streaks (locally limited deviations in homogeneity in a glass, with a length of 0.1 mm to 2 mm). Inclusions are foreign bodies which are present in an optical glass and may result, for example, from contamination during melting, incomplete melting of substrate batches, and wall materials with low solubility. Moreover, reactions during glass melting may give rise to bubbles. The bubbles are almost completely eliminated in the refining step during glass melting.

In one preferred embodiment, the MAS glass of the invention obtainable by the process of the invention described above is characterized in that it contains less than 100 ppm of crystallization-promoting elements.

In one preferred embodiment, the MAS glass of the invention obtainable by the process of the invention described above is characterized in that more than 80%, preferably more than 90%, more preferably more than 95% of the Al atoms present therein are in four-fold coordination to the oxygen.

This has the advantage that it simplifies homogeneous curing and the formation of an X-ray-amorphous glass and makes crystallization more difficult.

The glass structure and the incorporation of the individual cations change depending on the MgO/Al₂O₃ ratio. A high fraction of Mg(II) leads to formation of non-bridging oxygens (NBO), which lower the viscosity. The fraction of non-bridging oxygens is dependent on the MgO/Al₂O₃ ratio. While the ratio is ≤1, magnesium is incorporated as a glass former, i.e., one Mg(II) ion stabilizes two [AlO₄]⁻ tetrahedra (tetravalent aluminum). If the Mg(II) fraction is increased further, then Mg(II) is incorporated as a glass modifier, so leading to the formation of NBOs and thus lowering the viscosity.

Determining the fraction of the Al atoms present in four-fold coordination is accomplished by means of the measurement method MQMAS-NMR (multiple quantum magic angle spinning nuclear magnetic resonance spectroscopy).

Here, for example, NMR spectra are recorded on a Varian VNMRs 11.7 T NMR spectrometer, using a Varian mm 1.6 T3-MAS-NMR probe at rotational frequencies of 35 kHz. To support the results, the ²⁷Al-MAS-NMR spectra are likewise generated in a field of 7 T (Bruker Avance III spectrometer; 4 mm triple resonance probe; rotational frequency 10 kHz).

In one preferred embodiment, the MAS glass of the invention obtainable by the process of the invention described above is characterized in that the coefficient of thermal expansion (CTE) of the MAS glass is greater than 3.0×10⁻⁶ K⁻¹ (300 to 600° C.), preferably greater than 4.0×10-6 K⁻¹ (300 to 600° C.) and more preferably greater than 4.5×10⁻⁶ K⁻¹ (300 to 600° C.).

The coefficient of thermal expansion (CTE) is a physical property which describes the characteristics of a substance in terms of changes in its dimensions when temperatures change. The effect responsible for this is that of thermal expansion. Since for many substances thermal expansion is not uniform across all temperature ranges, the thermal expansion coefficient is itself also temperature-dependent and is therefore for a reference temperature or a specified temperature range.

The coefficient of thermal expansion (CTE) is determined in accordance with ISO 7991-1998.

In one preferred embodiment, the MAS glass of the invention obtainable by the process of the invention described above is characterized in that the MAS glass has a glass transition temperature (Ig) of less than 900° C., preferably of less than 850° C. and more preferably of less than 800° C.

The glass transition temperature (T_{g}) is a physical property wherein a glass exhibits the greatest change in deformation capacity. The glass transition temperature separates the lower brittle, energy-elastic range, in which the substance is present as glass, from the upper soft, entropy-elastic range.

The glass transition temperature (T_{g}) is determined in accordance with ISO 7884-8:1998.

An advantage of a lower glass transition temperature is that the oxides utilized for producing the glass become miscible at lower temperatures and the glass produced is deformable at lower temperatures.

In one preferred embodiment, the MAS glass of the invention obtainable by the process of the invention described above is characterized in that it is not fire-polished.

Fire polishing is cost-intensive and may lead to deformations in component geometry, and hence is deemed disadvantageous.

After a glass part has been ground, the glass surface is usually rough and matt, and so fire polishing is employed in order to achieve a smooth surface through heating and flow of the surface. In this one preferred embodiment according to the invention, no fire polishing is required.

In one preferred embodiment, the MAS glass of the invention obtainable by the process of the invention described above is characterized in that the plasma etching rate of the MAS glass is below that of a quartz glass by more than 50%, preferably by more than 70% and more preferably by more than 85%.

In one preferred embodiment, the MAS glass of the invention obtainable by the process of the invention described above is characterized in that the plasma etching rate of the MAS glass is below 50 nm/min, preferably 40 nm/min and more preferably 30 nm/min.

The plasma etching depth is determined by measuring the etched profile (that is, a section through the etching step) in an optical microscope. The plasma etching rate is defined as an etching rate which results from the etching of a material by means of plasma. The etching rate is defined by the thickness of the material to be etched that is ablated per unit time. Relative etching rates come about from the ratios of the etching rates of the materials under comparison. The etching rate is determined by measuring the etched profile in a time range.

The present invention further relates to a component comprising the MAS glass described above.

In this context, all definitions and preferred embodiments recited above for the process of the invention and for the MAS glass of the invention are valid analogously for the component.

In one preferred embodiment, the component of the invention is used in semiconductor production, preferably in an etching chamber.

In this context, all definitions and preferred embodiments recited above for the process of the invention and for the MAS glass of the invention are valid analogously for the use of the component.

The invention is elucidated below in more detail on the basis of non-limiting examples.

The skilled person will appreciate that in place of MgO and precursors thereof, the use of CaO and precursors thereof also leads to comparable results.

### EXAMPLES

Glasses were produced at temperatures between about 1600 and 1700° C. Here, 300 g of each of the mixtures indicated in Table 1 were melted in Pt and Pt/Rh crucibles. The production conditions are evident in summary form from Tables 1 and 2. The glasses were first melted at the temperature T₁ for the time t₁. The cooled melt was subsequently ground and again melted at the temperature T₂ for the time t₂. After the second melting procedure, the melt was poured into a metal mold. The melting time is governed primarily by the time taken for a clear and bubble-free melt to form. Correspondingly, longer times (and higher temperatures) were needed in the case of compositions with high melting points. For certain compositions, the amount of the glass was varied as well, as particular geometries were required which in some cases necessitated a very high fill level in the crucible. For these compositions, correspondingly, the melting procedure also took a longer time.

It was found that glass number 1 (Tables 1 & 2) can be melted even at a temperature of 1560° C. However, it takes a comparatively long time for the laboratory melt in that case to be bubble-free. To ensure better homogeneity and to allow the glass to be poured more effectively, a temperature of 1650° C. was selected for production. The glass was subsequently poured into a steel mold coated with release agent, and the mold was transferred to a lehr. The lehr here was preheated to 810° C. and was switched off to ensure slow cooling (1-2 K/min) to RT.

TABLE 1
Composition of the MAS glasses

| | MgO in | Al₂O₃ in | SiO₂ in |
|---|---|---|---|
| Number | mol % | mol % | mol % |
| 1 | 30 | 10 | 60 |
| 2 | 25.3 | 19 | 55.7 |
| 3 | 35 | 15 | 50 |

TABLE 2
Melting temperature and melting time of the MAS glasses

| | T₁ in | t₁ in | T₂ in | t₂ in |
|---|---|---|---|---|
| Number | ° C. | h:min | ° C. | h:min |
| 1 | 1650 | 03:00 | 1650 | 06:40 |
| 2 | 1700 | 03:05 | 1650 | 05:30 |
| 3 | 1620-1650 | 03:05 | 1650 | 04:30 |

A summary of the properties ascertained via dilatometry (heating rate 5 K/min) is given in Tab. 3. It is known that glasses with a low CTE frequently possess high glass transition temperatures. This is usually a problem in the context of joining applications in the area of fuel cells. In that case, high CTES and high glass transition temperatures equally are required. In the MAS system it is evident that Ig and CTE do not follow exactly the same compositional trends, however. The higher the SiO₂ content, the lower the CTE. A high MgO content raises the CTE. The glass transition temperature increases in the direction of rising SiO₂ concentrations. This dependence, however, is not as strong as the dependence on the MgO/Al₂O₃ ratio, and so the highest glass transition temperature is not established at the highest SiO₂ content. Another reason for this is that the glass structure and the incorporation of the individual cations change as a function of the MgO/Al₂O₃ ratio. A high fraction of Mg(II) leads to formation of non-bridging oxygens (NBO), which lower the viscosity. However, Mg(II) can be incorporated not only as a network modifier but also as a network former in the glass. The fraction here is dependent on the MgO/Al₂O₃ ratio. While the ratio is ≤1, magnesium is incorporated as a network former, i.e., one Mg(II) ion stabilizes two [AlO₄]⁻ tetrahedra. If the Mg(II) fraction is increased further, then Mg(II) is incorporated as a network modifier, so leading to the formation of NBOs and thus lowering the viscosity.

TABLE 3
Glass transition temperature, coefficient of thermal expansion
and dilatometric softening point of the MAS glasses

| | | CTE_{300-600° C.} | |
|---|---|---|---|
| | Glass | (coefficient | Dilatometric |
| | transition | of thermal | softening |
| | temperature | expansion) | point (Tₛ) |
| Number | (T_{g}) in ° C. | in 10⁻⁶ K⁻¹ | in ° C. |
| 1 | 778 | 5.3 | 842 |
| 2 | 796 | 4.8 | 864 |
| 3 | 770 | 5.8 | 828 |

To determine the crystallization propensity, small pieces of glass were melted in a corundum crucible. For this purpose, the crucible was charged with glass at RT and then transferred to the oven, which was preheated to 1700° C. After a few minutes, the oven was cooled at 5 K/min. This cooling rate can be maintained to around 1000° C. At lower temperature, accordingly, the oven cools more slowly. The MAS glasses obtained are clear and X-ray-amorphous.

The etch homogeneity of the MAS glasses is determined by steps as follows: 1. cleaning of the MAS glass, 2. masking of defined glass regions with Kapton tape, and 3. an etching operation.

The MAS glasses are cleaned by the following wet-chemical steps:
1. 100% ultrasound for 10 min with Tickopur R33 (at 5%),
2. solvent cleaning with acetone and isopropanol, and
3. rinsing with DI water and drying.

Tickopur R33 (at 5%) is a universal ultrasound cleaner which contains 5 to 15% anionic surfactants, 5 to 15% phosphate, less than 5% nonionic surfactants, less than 5% silicate and complexing agent.

The masking of defined glass regions with Kapton tape takes place by partial taping off of defined regions of the substrate with plasma-stable Kapton film.

The etching operation for smoothing the surface of the MAS glasses of the invention is carried out in the Sentech Si-500 apparatus. In this operation, the following parameters are set in the associated execution software as follows:
1. ICP 500 W,
2. HF bias 200 W,
3. flow control 100% (0.25 Pa),
4. CHF₃ 30 sccm,
5, etching time (cyclical, 2 min etching, 3 min cooling),
6. He backside cooling 1000 Pa,
7. heating power 0% and
8. Al sampling.

The total time for the etching operation lasts 40 min.

The surface roughnesses of the glasses were determined in accordance with ISO 4287-1:1984. The etching depths were determined by measuring the etch profile (that is, a section through the etching step) in an optical microscope. The etching rates were determined as a function of time relative to the etching depth.

TABLE 4
Etching rates, etching depths and surface
roughness of the MAS glasses

| | | | | Etching | Mean |
|---|---|---|---|---|---|
| | Etching | | | rate | etching |
| | rate | Ra | Rz | relative | depth |
| Number | [nm/min] | [μm] | [μm] | to quartz | [μm] |
| 1 | 30.1 | 0.006 | 0.030 | 0.12 | 1.20 |
| 2 | 20.4 | 0.001 | 0.004 | 0.08 | 0.81 |
| 3 | 29.6 | 0.001 | 0.006 | 0.12 | 1.18 |
| Reference | 250.5 | 0.001 | 0.016 | | 10.2 |
| sample: | | | | | |
| undoped | | | | | |
| quartz | | | | | |

From Table 4 it is evident that the MAS glasses of the invention exhibit a markedly improved etching rate and comparable etch homogeneity by comparison with the undoped quartz reference sample.

1. A process for producing an MAS glass, wherein
a) mixing 10 to 40 mol % of MgO, 5 to 30% mol % of Al₂O₃ and 40 to 70 mol % of SiO₂ or precursors of these raw materials,
b) melting the mixture from step a),
c) cooling and comminuting the melt from step b) to give particles having a diameter of less than 10 mm,
d) heating and melting the particles from step c), and
e) cooling the melt from step d).

2. The process of claim 1, wherein
steps c), d) and e) are carried out repeatedly, with the cooled melt in step c) being in each case the melt produced before by step e).

3. The process of claim 1, wherein
the mixture in steps b) and/or d) is heated to a temperature of 1200 to 2000° C.

4. The process of claim 1, wherein
the duration of step b) is 0.1 to 10 hours.

5. The process of claim 1, wherein
the duration of step d) is 0.1 to 10 hours.

6. The process of claim 1, wherein
the mixture from step d) is cooled in step e) to a temperature of below 25° C.

7. The process of claim 1, wherein
the mixture from step d) is cooled in step e) initially rapidly to a temperature of 600 to 900° C. and subsequently more slowly to a temperature of below 25° C.

8. The process of claim 1, wherein
the mixture in steps b) and/or d) is heated in Pt and/or Pt/Rh crucibles.

9. The process of claim 1, wherein
the mixture is cooled in step e) in a steel mold coated with release agent, in a lehr.

10. An MAS glass obtained by the process of claim 1.

11. The MAS glass of claim 10, comprising 10 to 40 mol % of MgO, 5 to 30 mol % of Al₂O₃ and 40 to 70 mol % of SiO₂,
wherein
the MAS glass is X-ray-amorphous and in that the surface of the MAS glass after the etching operation specified in the description with steps 1 to 3 has a mean roughness (Rₐ) of less than 50 nm, the mean roughness (Rₐ) having been determined in accordance with ISO 4287-1:1984.

12. The MAS glass of claim 10, comprising 20 to 40 mol % of MgO, 5 to 30 mol % of Al₂O₃ and 40 to 70 mol % of SiO₂.

13. The MAS glass of claim 10, wherein
the MAS glass contains less than 0.01 mol % of additions of materials comprising fluorine compounds and/or yttrium compounds.

14. The MAS glass of claim 10, wherein
more than 80%, of the Al atoms present in the MAS glass are in four-fold coordination to the oxygen.

15. The MAS glass of claim 10, wherein
the coefficient of thermal expansion (CTE) of the MAS glass is greater than 3.0×10⁻⁶ K⁻¹ (300 to 600° C.).

16. The MAS of claim 10, wherein
the MAS glass has a glass transition temperature of less than 900° C.

17. The MAS glass of claim 10, wherein
the relative plasma etching rate of the MAS glass is below that of a quartz glass by more than 50%.

18. A component comprising an MAS glass of claim 10.

19. The component of claim 18, wherein
the component is not fire-polished.

20. (canceled)

21. (canceled)
